(19) United States
(12) Patent Application Publication
(10) Pub. No.: US 2019/0155986 A1
(43) Pub. Date: May 23, 2019

(54) Method and System for the Creation of an H-Spline Based Data Structure, Data Storage, and Data Representation

(71) Applicant: Ecole Polytechnique Federale De Lausanne (EPFL), Lausanne (CH)

(72) Inventors: Daniel Schmitter, Renens (CH); Pablo Garcia-Amorena, Lausanne (CH); Zsuzsanna Püspöki, Lausanne (CH); Michael Unser, Ecublens (CH)

(21) Appl. No.: 15/817,236

(22) Filed: Nov. 19, 2017

(51) Int. Cl. G06F 17/50; G06F 17/30

(52) U.S. Cl. CPC G06F 17/5086; G06F 17/30946; G06F 17/30994; G06F 17/5004

(57) ABSTRACT

A method for generating a data structure to digitally represent a geometrical object based on H-splines, the method being performed on a computer device having a data processor and memory, the method including the steps of creating a first data structure and storing a plurality of control points and higher order derivatives that define the geometrical object in a parameter domain using the H-splines in the first data structure of the memory, creating a second data structure and storing coordinate data that define the geometrical object as a coordinate data model in the second data structure of the memory, and creating and storing a connectivity array in the memory that links the plurality of control points of the parameter domain to the coordinate data of the coordinate data model.

### FIELD OF INVENTION

The present invention relates to a system, method and device for computer-aided design, computer-aided engineering in general and computer-aided shape modeling, and more specifically to a method to create a connectivity array and a data structure, data storage and data representation to process H-splines which possibly involves, but is not limited to, the graphical representation of an object using H-splines.

### BACKGROUND

The computer aided design CAD, visualization, representation, and construction of shapes play an important role in the manufacturing industry, as well as the gaming, animation industry or the computer graphics industry. In the architecture, engineering, construction and manufacturing (AECM) industry and also industries involved in product and industrial design CAD might also be combined with computer aided engineering (CAE) or computer aided manufacturing (CAM) which might include finite element analysis (FEA) or isogeometric analysis (IGA). Generally, CAE consists in the generation of an analysis suitable geometry (ASG) using CAD and solving the mathematical engineering problem—typically a complex set of differential equations—using FEA. This type of CAE is commonly used throughout the different manufacturing industries such as the aerospace, automotive, naval or mechanical industry.

The above mentioned computer-aided methods all require accurate representations of shapes either for pure computational purposes or combined with visualization and simulation. Typically a mathematical or geometrical model needs an underlying hardware structure that allows to run digital algorithms in order to store, process, visualize, and display shapes or shape-related computations. Several data storage and displaying hardware architectures have been invented and proposed because they are indispensable for any shape representation model to be run on an electronic device such as a computer, tablet or, more generally, an electronic device.

The most commonly used geometric models for computer-aided shape representation are related to either non-uniform rational B-splines (NURBS), subdivision or polygon mesh models. For CAD related to engineering and manufacturing, NURBS have become an industry standard since the late 1970s because of their convenient mathematical properties. NURBS enable interactive and smooth free-form surface modeling for organic shape design and they are suitable to exactly represent circles and ellipses, which are important shape primitives used in CAD. Today, many efficient and stable numerical algorithms exist to construct CAD objects using NURBS. However, the representation of NURBS objects is limited by the underlying rectangular parameter domain, which makes it impossible to model surfaces with arbitrary topology. Therefore, in practice complex objects are modeled by concatenating several NURBS patches.

Some drawbacks of NURBS are that in practice, it is usually not possible to construct physically tight boundaries between different NURBS patches and, moreover, they are only globally refinable, which results in an excess of parameters and increases the complexity of a CAD model. These drawbacks are reasons why CAD with NURBS is tedious and time-consuming. An extension of NURBS, called ‘T-splines’, partially solves this issue.

However, also the interactive manipulation of NURBS and T-spline objects is not intuitive because the parameters, called ‘control points’, that a user can displace with a device such as a computer-mouse, do not lie on the boundary of an object itself, which, as a result, significantly slows down the interactive design process.

Also, there are weights in the T-spline and NURBS formulation that have no physical interpretation, are non-intuitive to handle and render computations more complex.

Furthermore, NURBS and T-splines only allow coupled control of geometrical quantities that depend on higher order derivatives of an object such as tangent planes or curvature. Therefore, in NURBS and T-spline modeling, the user can only control a shape by changing the vertices of the so called ‘control polygon’. Because these vertices do not interpolate the shape, the more control points are used, the more difficult it becomes for the user to associate a control point with the corresponding region of the surface that is affected.

The use of H-splines to construct watertight surfaces and volumes drastically alleviates the drawbacks of NURBS and T-spline-based CAD modeling as well as the CAD-related engineering aspects, as explained in United States patent application with the Ser. No. 15/177,303 filed on Jun. 8, 2016, this reference herewith incorporated by reference in its entirety. H-splines allow direct control of smooth surfaces or volumes and also provide augmented access to a geometrical object, for example an object represented using Cartesian coordinates typically referred to as x-, y-, z-coordinates, which can then be deployed in an interactive CAD environment to decouple the direct control of tangents, curvature, and other geometrical quantities. H-splines allow for local refinement of an object and all the H-spline parameters typically directly lie on the CAD object itself resulting in more intuitive shape manipulation and shape modeling. Moreover, a more localized control of the CAD object is possible with H-splines compared to NURBS or T-splines.

Accordingly, in light of the above described deficiencies in methods and systems for modeling, generating, modifying, computing, and representing CAD objects, and more generally, geometrical objects and shapes and creating related digital representations advanced technologies and methods are desired, to further improve the design of efficient hardware-related systems to represent, process, and compute H-spline shapes in the context of for example but not limited to CAD, CAE, FEA, and IGA for their use in design, representation, manipulation, computation, and modification of CAD objects, as well as subsequent mesh generation and the related digital processing in its broadest sense. More precisely, it is desirable to deploy H-spline-based CAD object storage and processing methods in any kind of computer-dependent or digital environment.

### SUMMARY

According to one aspect of the present invention, a method for generating a data structure to digitally represent a geometrical object based on H-splines is presented, the method being performed on a computer device having a data processor and memory. Preferably, the method includes the steps of creating a first data structure and storing a plurality of control points and higher order derivatives that define the geometrical object in a parameter domain using the H-splines in the first data structure of the memory, creating a second data structure and storing coordinate data that define the geometrical object as a coordinate data model in the second data structure of the memory, and creating and storing a connectivity array in the memory that links the plurality of control points of the parameter domain to the coordinate data of the coordinate data model.

According to another aspect of the present invention, a system for generating a data structure to digitally represent a geometrical object based on H-splines is provided, the system including a computer device having a data processor and memory. Preferably, the data processor is configured to create a first data structure and store a plurality of control points and higher order derivatives that define the geometrical object in a parameter domain using the H-splines in the first data structure of the memory, create a second data structure and store coordinate data that define the geometrical object as a coordinate data model in the second data structure of the memory, and create and store a connectivity array in the memory that links the plurality of control points of the parameter domain to the coordinate data of the coordinate data model.

According to still another aspect of the present invention, a non-transitory computer readable medium is provided, the computer readable medium having computer instruction code recorded thereon, the computer instruction code configured to perform a method for generating a data structure to digitally represent a geometrical object based on H-splines. Preferably, the method comprising the steps of creating a first data structure and storing a plurality of control points and higher order derivatives that define the geometrical object in a parameter domain using the H-splines in the first data structure of a memory of the computer, creating a second data structure and storing coordinate data that define the geometrical object as a coordinate data model in the second data structure of the memory of the computer, and creating and storing a connectivity array in the memory that links the plurality of control points of the parameter domain to the coordinate data of the coordinate data model.

In accordance with a preferred embodiment of the present invention, one aspect of the present invention, a computer system having a hardware processor, a memory, possibly a storage medium and possibly a graphics processing unit (GPU) is provided to configure the hardware such that it implements an efficient data representation or storage of a geometrical H-spline object, the method enabling computational or user-interactive data manipulation. This step involves the creation of a digital structure for H-spline based geometry in memory or on a computer-readable storage medium, which includes the digital representation of the H-spline functions and the geometrical object.

According to another aspect of the present invention, a computer system having a hardware and memory is provided to store and represent the geometrical H-spline object such that the created digital data structure simulates a physical link between the control points which lie on the surface and its higher order partial derivatives and the underlying parameter domain which is directly linked to the hardware-based representation. Thereby, each control point of the H-spline object represents a digital entity on the hardware having a physical address in memory.

According to another aspect of the present invention, a system for a digital graph-based representation of an H-spline object is provided, the graph representing the geometry and topology of the geometrical object, the graph being stored as arrays of coordinates representing vertex points, faces, and connectivity information, each element of the graph being virtually linked to the digital H-spline object and physically linked to the memory represented as hardware.

According to yet another aspect of the present invention, a method for element-wise partitioning and memory representation of a geometrical H-spline object is provided, each element representing one base unit of the data structure which can be individually manipulated and enabling an efficient access and processing of the data.

According to still another aspect of the present invention, a non-transitory computer readable medium having computer instructions recorded thereon is provided, the computer instructions configured to perform a method when executed on a hardware processor of a computer having memory a display and possibly a graphics processing unit (GPU). The system configured as processing unit enabling to process the data structure, which represents the H-spline based geometry in memory onto a GPU or by other means input the related digital representation to a rendering pipeline in order to render and display the geometrical object on a display, possibly as a resampled digitally generated mesh.

The above and other objects, features, and advantages of the present invention and the manner of realizing them will become more apparent, and the invention itself will best be understood from a study of the following description with reference to the attached drawings showing some preferred embodiments of the invention.

### BRIEF DESCRIPTION OF THE SEVERAL VIEWS OF THE DRAWINGS

FIG. 1 shows a simplified exemplary schematic diagram of a method and a system for displaying an H-spline based object on a graphical display 22, according to one aspect of the present invention;

FIG. 2 shows a schematic exemplary representation illustrating the links between a representation of a geometric object O in the parameter domain u, v and the coordinate domain x, y, z, and a first data structure DS1 for the data of the parameter domain, and the second data structure DS2 of the coordinate domain, and the linking with the connectivity array CA, according to still another aspect of the present invention;

FIGS. 3A and 3B show an exemplary representations of geometric object O that is defined by control points CP in the parameter domain u, v using the first data structure DS1 and as a coordinate data model in the coordinate domain x, y, z, using the second data structure DS2, with FIG. 3A showing the basic geometric object O, and FIG. 3B showing a sampled variant of the geometric object O, to increase its resolution;

FIG. 4 shows a schematic exemplary representation of first data structure DS1, second data structure DS2, and the connectivity array CA that establishes a unique mapping function from each control point CP in the parameter domain u, v, and to a corresponding control point CP in the coordinate domain x, y, z;

FIG. 5 illustrates exemplarily and schematically the independent faces F of geometric object O, possible representing control points CP and control points that interpolate higher order derivatives, that together generate the overall data of the first data structure DS1 that is required to represent the geometric object O;

FIGS. 6A and 6B exemplarily show the connections or links established between the connectivity array CA and the first and second data structure DS1 and DS2, having distribution units DU and H-spline data representation units HDR, with FIG. 6A showing an example with the first nine (9) control points CP1 to CP9 representing the vertices of the exemplary geometrical object O of FIG. 3A of the first data structure DS1 of the parameter domain that are linked to a first distribution unit DU1, and the first nine (9) control points CP1 to CP9 of the second data structure DS2 of the coordinate domain that are linked to a first H-spline data representation unit HDR1, and a bidirectional connection between DU1 and HDR1, and FIG. 6B showing an example for the next nine (9) control points CP10 to CP18 interpolating the higher order derivatives that are linked to a second distribution unit DU2, and the next nine (9) control points CP10 to CP18 of the second data structure DS2 of the coordinate domain that are linked to a second H-spline data representation unit HDR2, and a bidirectional connection between DU2 and HDR2;

FIGS. 7A to 7E show schematic views of a method or process to encode local refinement in the data structures DS1 and DS2, based on the exemplary geometrical object O of FIG. 3A, in which new control points are generated as refined control points CPR, leading to a refined surface or geometric object O, with FIG. 7A showing a simplified geometric representation of the addition of the control points CPR, FIG. 7B showing a representation of steps of a process that adds new data for the refined control points CPR in both the parameter domain u, v, and the coordinate domain x, y, z, FIG. 7C showing a schematic representation of the newly generated data and the effects on the distribution units DU, the H-spline data representation units HDR, and the first and second data structures DS1, DS2, FIG. 7D showing a method representing the data flow and interaction between the first data structure DS1, the connectivity array CA, and the second data structure DS2, and the consequential addition of new control points as refined control points CPR, FIG. 7E exemplarily representing a new iteration of refinement to add additional refined control points to an already refined surface;

FIG. 8 shows an exemplary flowchart showing the data flow between different method steps for linking the first data structure DS1 to the second data structure DS2 and vice versa via the connectivity array CA, and the different hardware elements of FIG. 12 that may come into play;

FIGS. 9A to 9B show exemplary schematic views of the connectivity array CA and its connection to the first and second data structures DS1, DS2, with FIG. 9A representing links between first data structure DS1 and the distribution unit DU of connectivity array DA, and the additional data and information of the distribution unit DU, and FIG. 9B showing links between second data structure DS2 and the H-spline data representation unit HDR of connectivity array DA, and the additional data and information of the H-spline data representation unit HDR;

FIGS. 10A and 10B schematically show a representation of a sampled geometric object O in the parameter domain, with FIG. 10A showing a representation of an exemplary data structure representing the control points CP in the parameter domain and different faces including faces that have been locally refined with different refinement factors, and FIG. 10B showing sampled surface;

FIG. 11 shows a schematic view o f a processing device having a graphics processing unit 31 and a central processing unit 27, and random-access memory 29 for storing the data structures DS1, DS2, the connectivity array CA, and user data input units, according to still another aspect of the present invention; and

FIG. 12 shows a schematic, perspective view of a computer system that can be used for implementing the method to generate and represent a geometric object using H-splines.

Herein, identical reference numerals are used, where possible, to designate identical elements that are common to the figures. Also, the images may be simplified for illustration purposes and may not be depicted to scale.

### DETAILED DESCRIPTION OF THE SEVERAL EMBODIMENTS

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

According to some aspects of the present invention, a system and a method are provided that allow strongly extending and improving upon existing systems used to represent and digitally generate NURBS or T-splines. Generally, with respect to NURBS and T-splines, it is not possible to interpolate neither a geometrical object with a smooth function that has at least one continuous derivative everywhere, i.e. that is C¹, nor is it possible that the control points have a physical meaning in the parameter domain. Les Piegl. “On NURBS: a Survey.” IEEE Comput. Graph. Appl., Vol. 11, No. 1, January 1991, pp. 55-71. Therefore, the locations and mathematical coordinates of the NURBS or T-splines control points do not coincide with samples of the digital curve, surface or volume. This drawback translates into complicated data structures that are required to establish hardware-based systems which simultaneously handle physical user-inputs and the digital representation, generation, rendering, and drawing of the geometrical object. In other words, the geometrical limitations of NURBS and T-splines directly translate into data and memory structures that are complicated for digitally generating the geometry on a computer or any other electronic device.

Another limitation of NURBS is the impossibility of locally refining the geometry. It implies that a NURBS refinement of one region in the control mesh must necessarily result in a refinement of the entire control mesh, which results in an excess of parameters where not needed.

In contrast, T-splines provide a solution to this problem, however, they have a drawback as T-spline-based local refinement requires the introduction of new local coordinate systems for each region that must be refined. These local coordinates are independent of the global parameterization and introduce a certain parameterization-incompatibility. The formulation is algorithmic and becomes complicated if a lot of T-junctions need to be inserted in a mesh, which in turn, directly impacts the underlying data structure and implementation in memory of a T-spline geometry.

In publications from Sederberg, see Sederberg et al., “T-splines and T-NURCCs”, ACM Transactions on Graphics, Vol. 22, Issue 3, July 2003, pp. 477-478, and Sederberg et al., “T-spline Simplification and Local Refinement”, ACM Transactions on Graphics, Vol. 23, Issue 3, August 2004, pp. 276-283, these publications herewith incorporated by reference in their entirety, a generalized formulation of NURBS called “T-splines” has been presented. They allow constructing T-structures in the parameter domain by inserting T-junctions. Based on T-splines an algorithm was proposed to construct geometrically exact junctions between NURBS surface patches that have the same degree, which is a fundamental improvement of T-splines over NURBS.

Another limitation of T-splines and NURBS is that they do not allow the direct control of quantities from differential geometry, which depend on higher order derivatives such as controlling tangents, tangent planes, and curvature. If for example a tangent on a NURBS or T-splines surface needs to be modified, it necessarily also modifies the surface itself and all higher order derivatives, because these quantities cannot be decoupled.

As explained in United States patent application with the Ser. No. 15/177,303 filed on Jun. 8, 2016, this reference herewith incorporated by reference in its entirety, H-splines have allowed to overcome the limitations of NURBS and T-splines stated above. H-splines allow for the construction of interpolatory surfaces that are at least in C¹ or possibly have smoothness properties of arbitrary high order. This means that they are smooth, which allows organic shape design and the control points are directly lying on the surface. With H-splines, a local refinement in one or both directions u, v of the parameter domain of the control mesh is possible without changing the geometry of the surface. The operation is in-line with the global parameterization.

Furthermore, H-splines do not only interpolate the surface itself but also its higher order derivatives and cross-derivatives. Furthermore, they allow to directly control these quantities in a decoupled manner, meaning that they can be modified independently from each other. This enables to directly control the tangent planes or the curvature of a curve along one parameter direction. This feature allows for new possibilities in shape modeling because by modifying the tangent plane, the surface is locally modified without changing the location of the interpolating control point CP.

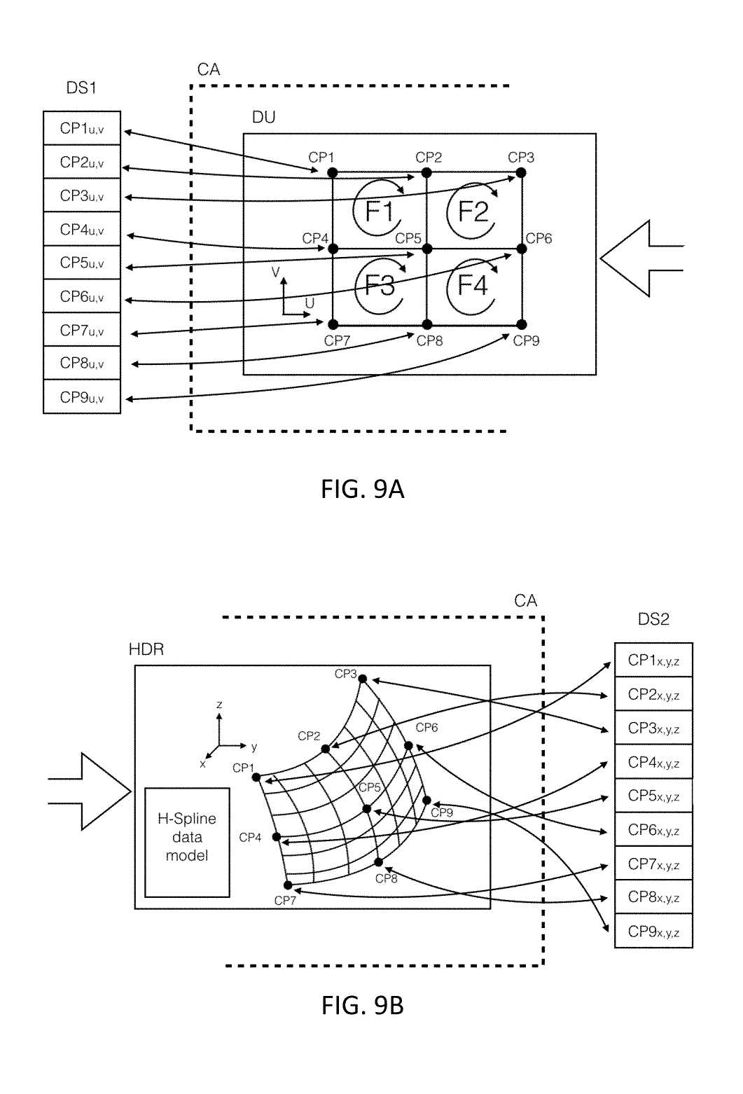

Furthermore, H-splines allow for a more localized control when displacing a control point CP (See FIGS. 9 and 13 of Ser. No. 15/177,303) than NURBS or T-splines because their support is minimal and considerably smaller.

Because NURBS and T-splines are polynomial, non-polynomial shapes such as conic sections only can be represented with rational expressions, which allow to represent, for instance, an arc of a circle. Then, several arcs are combined to represent a full circle. The generalized H-splines are not restricted to polynomials but can also represent exponential polynomials. This allows to exactly construct trigonometric, hyperbolic, and polynomial shapes or a combination of them. Thereby, no segments have to be patched together and fewer control points CP are needed than with NURBS or T-splines. Furthermore, transcendental shapes such as helices or spirals, which cannot be represented with NURBS are easily constructed with H-splines.

Another fundamental advantage for CAD modeling is that H-splines provide a simpler and technically more efficient way than NURBS or T-splines to create physically leak-proof junctions because the mapping of the control points CP from the parameter domain to the actual shape in 3D space is the same as the mapping of the parametric shape description itself, which is an essential simplification in the construction of physically watertight junctions. This is not possible with NURBS and other non-interpolating shape representations.

A continuous 1-dimensional function is represented using H-splines, for t ∈ [symbol] and k ∈ [symbol] it is defined as Φₖ(t) as

f(t)=ΣₖcₖΦₖ(t), Eq. (1)

where the coefficients cₖ ∈ [symbol] coincide with samples of the function f as well as samples of its derivatives up to any given order. The sum in Equation (1) is finite.

An H-spline function as described in Equation (1) can be refined, meaning that exactly the same function is represented with more control points. It implies that if a geometrical object is generated, such as a surface or volume, using H-splines, the same geometry can be represented with more control points without changing the geometry of the shape. This allows one to perform local and global surface refinements. The property that enables this processing step originates from the refinability property of the H-splines. For a positive integer m the refinement relation is specified by

Φₖ(t)=ΣᵢHᵢΦ_{k,i}(mt), Eq. (2)

where Hᵢ are suitable coefficients such that Equation (2) holds.

A parametric surface σ=(x, y, z) using H-splines is then given by:

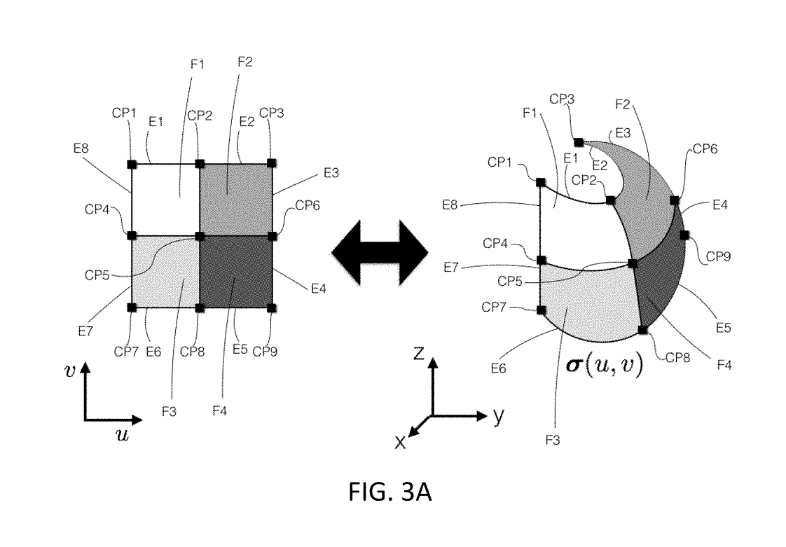

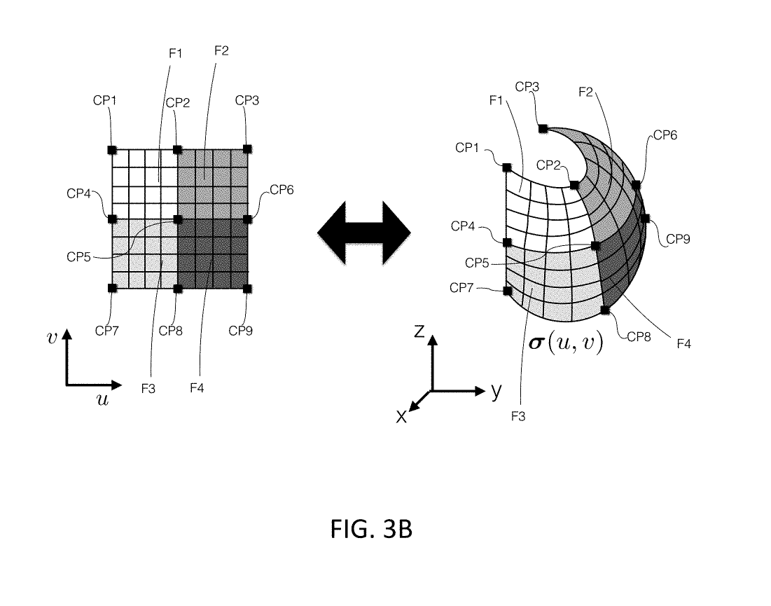

σ(u, v)=(x(u, v), y(u, v), z(u, v))=Σ_{k,l}c_{k,l}Φₖ(u)Φₗ(v) Eq. (3)

where c_{k,l} ∈ [symbol] ³ coincide with suitable points of the surface and its derivatives and possibly higher order derivatives and are herein referenced as control points CPi. They are represented using a first data structure DS1 that represents the parameter domain as well as using a second data structure DS2 using coordinate domain using coordinate data, for example a Cartesian coordinate system x,y,z as shown in FIG. 2 and FIG. 3A. In FIG. 3A, for representation and explanatory purposes, a simplified geometric object o is shown, being a sphere made of four faces F1 to F4, including control points CP1 to CP9. For simplification purposes, only the control points defining the corners of each face are shown, and not other control points that define higher order derivatives and faces representing higher order derivatives. A geometric object o is represented by more, additional, control points, which represent samples of the higher order derivatives of a, e.g. first derivative, second derivative, etc. These control points are arranged in the same way as shown in FIG. 3A, i.e. they have a representation in the parameter domain and as coordinate data and when arranged accordingly, they define the vertices of faces. The control points CP1 to CP9 as well as the control points that interpolate the higher order derivatives together contribute to the expression stated in Equation (3) to represent a; however, for simplicity and to facilitate representation, in FIG. 2 and FIG. 3A none of the higher order derivatives are shown.

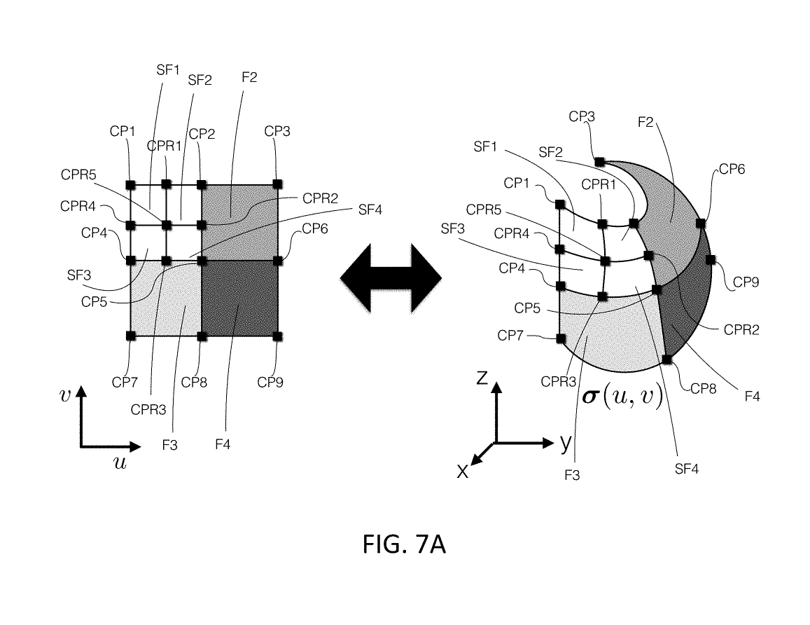

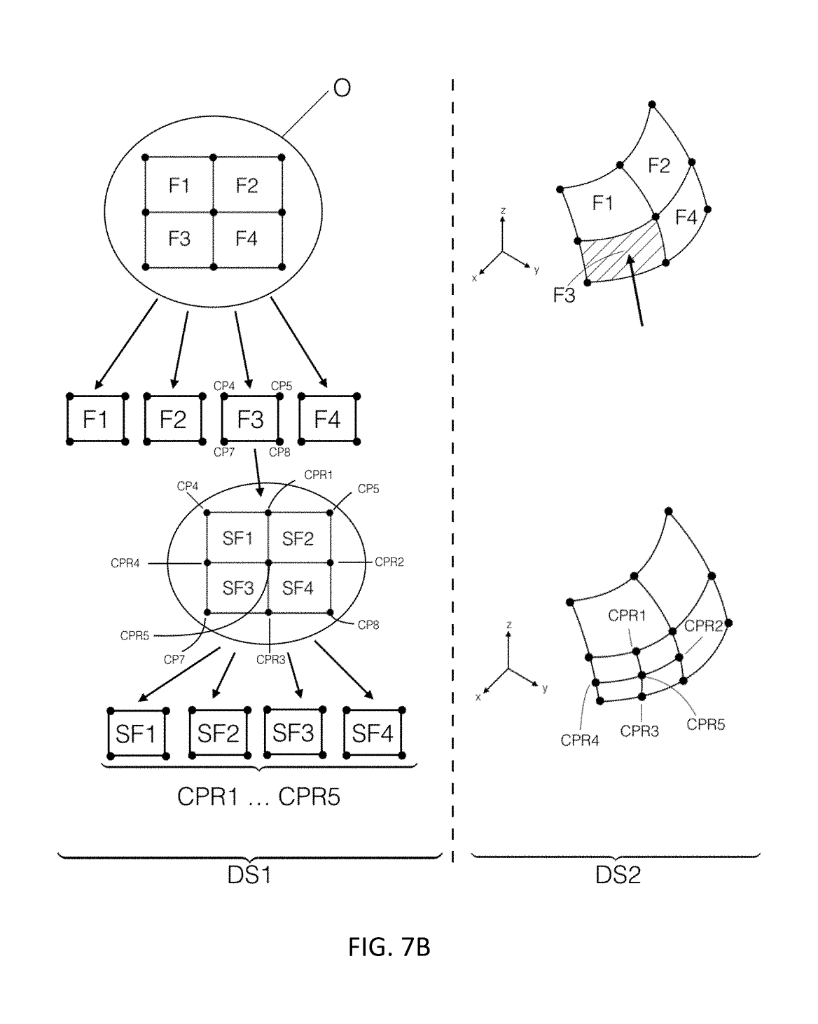

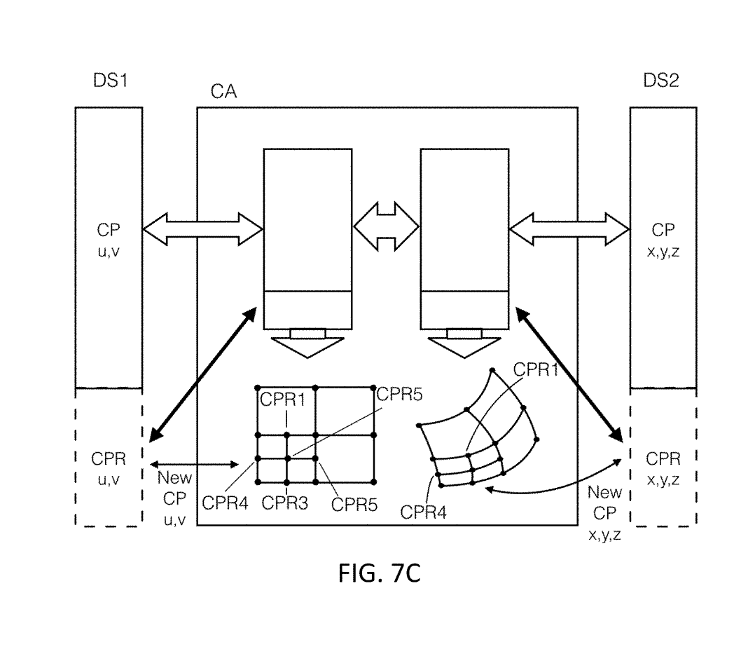

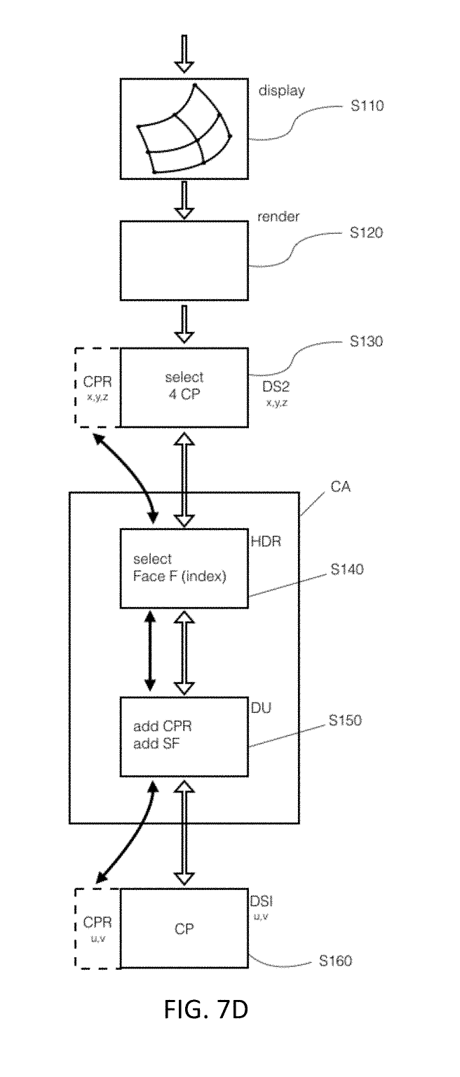

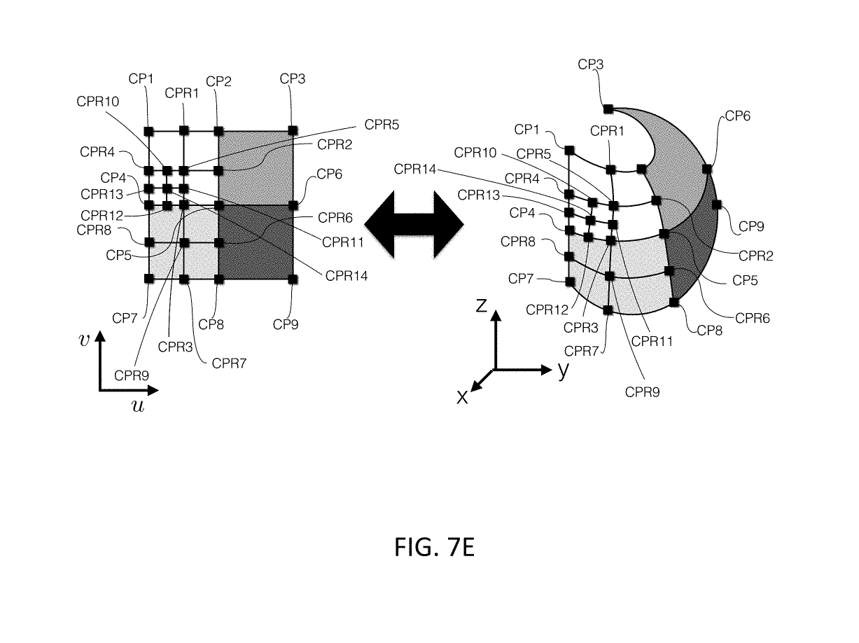

An elementary local refinement operation is achieved by refining one control point CPi of σ with the coordinates (p, q) for p, q ∈ [symbol] with respect to one direction of the parameter domain. This is schematically shown as an example in FIG. 7A. In FIG. 7A, control points CP1 to CP9 are shown to be arranged such that they define four faces F1 to F4 whereas face F1, has been locally refined and is subdivided into the subfaces SF1, SF2, SF3, and SF4. Also, in FIG. 7A it is shown how the local refinement operation has generated additional control points CPR1 to CPR5, which define the vertices or corners of the subfaces SF1 to SF4. The local refinement operation is schematically represented in FIG. 7A in the parameter domain on the left and in the coordinate domain, for example Cartesian coordinates x, y, z, on the right. By performing a refinement operation on one control point CPi, in the parameter domain the corresponding vertex is replaced by several new H-junctions. This operation does not change the geometry of the surface. The refinement of a point c_{p,q} is expressed as

σ(u, v)=Σ_{k,l}c_{k,l}Φₖ(u)Φₗ(v)= [symbol] c_{k,l}Φₖ(u)Φₗ(v)+Φₚ(u) [symbol] c_{p,l}Φₗ(v)+Φₚ(u)c_{p,q}ΣᵢHᵢΦ_{q,i}(mv). Eq. (4)

The refinement of the surface point c_{p,q} will lead to new interpolating surface points as well as to points that interpolate their corresponding higher-order derivatives. The control points CPi that are subject to refinement generate new control points CPRi as exemplarily shown in FIG. 7A, which include newly generated data, with FIG. 7B on the left side showing a representation in the parameter domain, and on the right side in the coordinate domain, and this additional data in the form of control points CPRi are added to the first data structure DS1 and the second data structure DS2, as shown exemplarily in FIG. 7C. In this process, the connectivity array CA provides for a mapping between both the old control points CPi and the new refined control points CPRi, as further explained below. A local refinement operation can also be applied to several neighboring control points or even an entire row or column in the parameter domain and it can further be applied to already refined points CPRi, as exemplarily shown in FIG. 7E.

Moreover, H-splines allow for performing a direct surface control of the displayed graphical elements such as higher order derivatives. If we define

$${σ}^{( i , j )} ( k , l ) = {σ}^{( i , j )} ( u , v ) {\vert}_{u = k , v = 1} = \frac{{\partial }^{i + j} σ ( u , v )}{{\partial }^{i} u {\partial }^{j} v} {\vert}_{u = k , v = 1} , \qquad Eq . ( 5 )$$

then, the surface formulation using H-splines implies that if the control points CPi, which interpolate the surface are displaced, the surface immediately changes. Similarly, the control of higher order derivatives that are related to the surface can directly be controlled. For example, modification of the control points CPi which interpolate the derivatives allow to control the tangents along the u-parameter- and v-parameter-direction at a particular surface point as well as changing the curvature or higher order derivatives.

It is possible to create watertight junctions between H-spline surfaces. With the use of H-splines it is possible to exactly represent any curve segment on a surface corresponding to a straight line segment in the parameter domain between any two given control points, which lie on a parameter line, as a possibly refined H-spline curve, where no additional control point is used to construct the curve segment than the ones that lie between the given control points.

All the operations and representations using H-splines mentioned above can directly and easily be extended to create solids or volumes and to perform the related computations, such as refinement or the creation of watertight junctions, on these objects. Thereby, the bivariate tensor-product structure is extended to the volumetric trivariate spline structure in a similar manner as it is done to represent volumes and solids in the case of NURBS or T-splines.

H-splines have the remarkable feature that they do not only interpolate geometrical object, i.e. the shape, but the control points also have a physical meaning in the parameter domain. This is not the case with non-interpolating shape representations such as NURBS, because its control points do not lie on the shape. This fundamental property allow to significantly simplify the design for an efficient hardware-based architecture to represent H-spline shapes because a direct and immediate link between the geometrical object represented as one data structure in hardware and its parameters and its representation as another data structure in hardware can be established through the invention of an H-spline specific connectivity array. A similar connection cannot be established for NURBS or T-splines because their control points do not have a physical relation with the geometrical object and, also, the weight parameters found in NURBS and T-splines have no physical meaning. However, no hardware-related H-spline based data architecture exists today to represent H-spline shapes for their efficient generation, construction, storage, processing, and computation and more generally, for an efficient use of H-spline shapes in a computer-based environment. In this respect, a data processing method and corresponding data structures are presented, to provide for a solution for the above discussed deficiencies.

With respect to an efficient and rapid data processing method, a connectivity array is presented with respect to the H-spline data structure, according to another aspect of the present invention. Because H-splines interpolate the geometrical object, e.g. a curve, surface, or volume, the control points that define the geometric object O and that a user can modify are directly linked to the digital representation as well as to the hardware system that is used to generate a digital H-spline object. Thereby, the geometric object O is stored in a first data structure DS1, which corresponds to its representation in the parameter domain u,v. A second data structure DS2 includes the coordinate data, which represents the geometric object in Cartesian coordinates as a coordinate data model, for example the classical x, y, z, coordinate system. Other coordinate systems can be used, for example but not limited to spherical coordinate systems, polar coordinate systems, cylindrical coordinate system, or other types of coordinate systems that can be used for computer graphic data processing. The unique representation of the geometric object O being a digital H-spline object is given by the connectivity array CA, which defines the relation between the first data structure DS1 and the second data structure DS2, thereby establishing the digital parameterization. The connectivity array CA includes all the essential information to link the first and the second data structure, DS1 and DS2, as well the connection between neighboring control points CPi, which represents an edge E as well as a surface region on the geometrical object enclosed by the control points CP, which represents a face F as shown in FIG. 3A.

The control points CPi, which define the geometric object O, have a data representation in the parameter domain u,v that is stored in a first data structure DS1. The same geometric object O also has a representation in Cartesian coordinates that is stored as coordinate data in the second data structure DS2. The connectivity array CA represents the unique bidirectional mapping function between the first and the second data structure DS1 and DS2, as a change to one data structure will simultaneously change the other data structure, but in different ways, as the data for the same object o are represented in different reference domains.

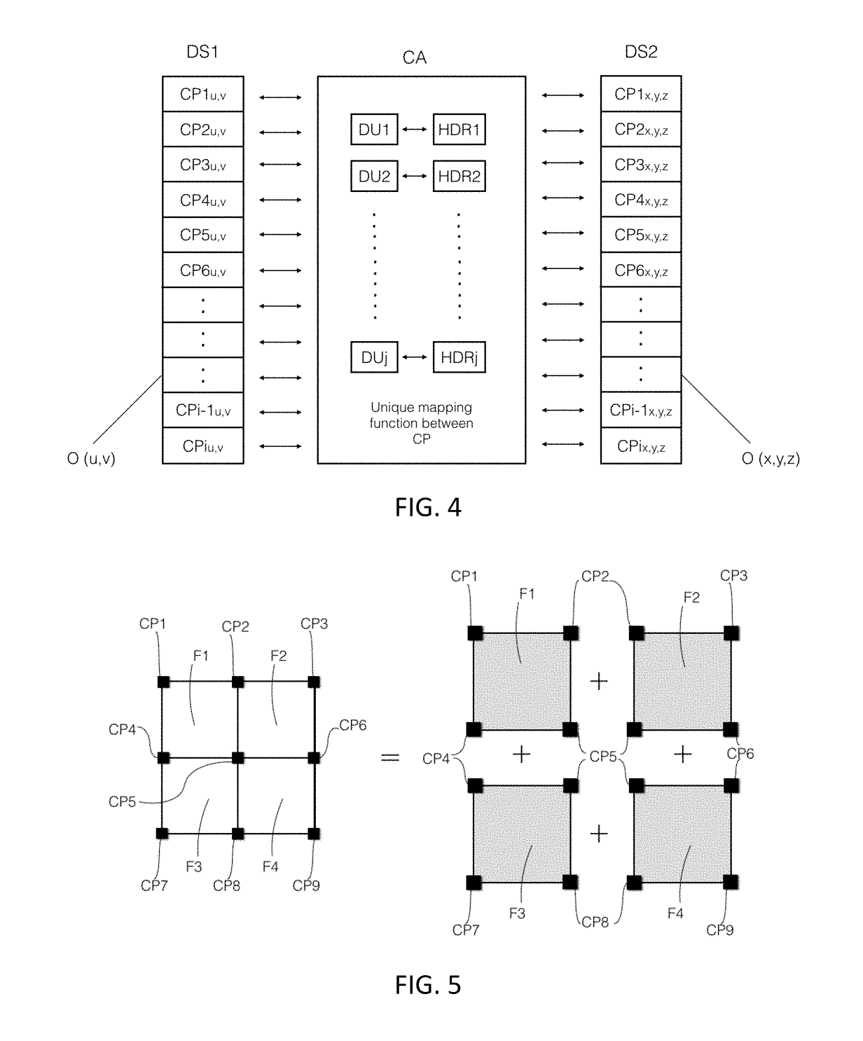

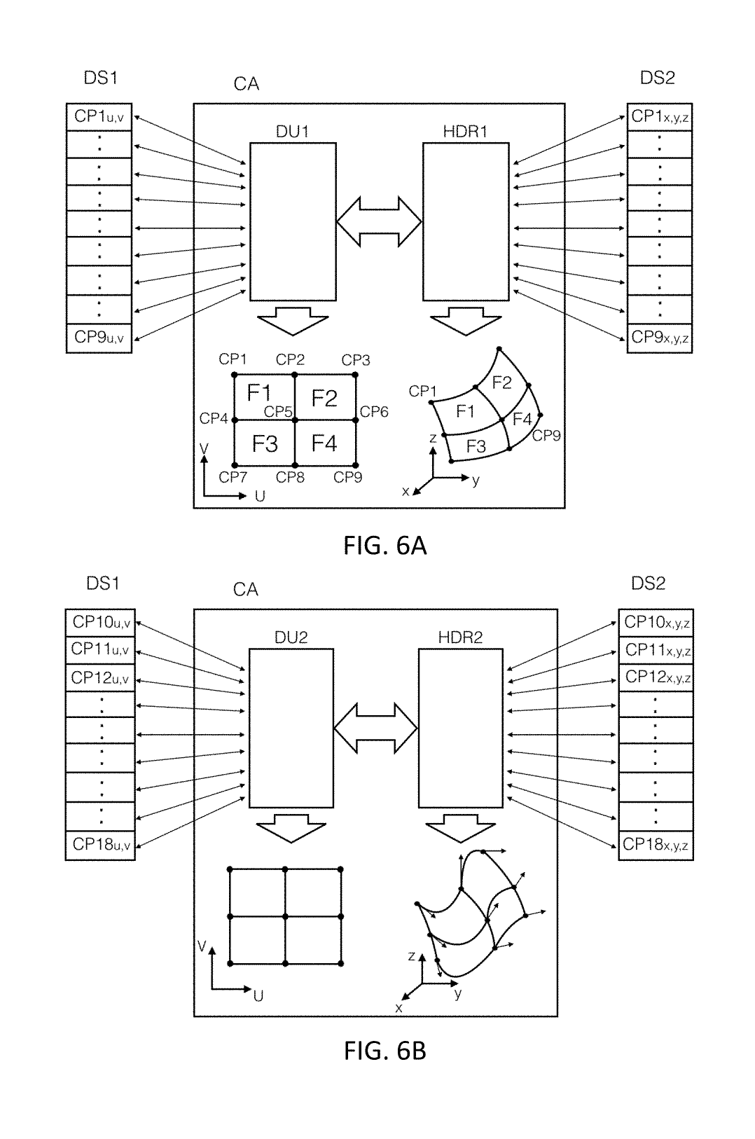

Connectivity array CA includes several distribution units DUj and H-spline data representation units HDRj, which are themselves hardware-based computation and processing units as schematically shown in FIG. 4. Different sets of distribution unit DUj processes a corresponding group of control points CPi, for example a set of distribution units DU1 processes one group of control points CP1 to CP9 that interpolate the surface of the geometric object O, as exemplarily shown in FIG. 6A for the surface shown in FIGS. 2-3. Also, a set of distribution units DU2 processes one group of control points CP10 to CP18 that interpolate or interpolate the same type of higher order derivative, for example the first derivative as shown in FIG. 6B or second derivative, etc. A distribution unit DU is an electronic processing unit configured to arrange a group of control points CPi such that a sub-group of control points CP define a face F, with neighboring faces F sharing two control points CP, whose connection defines an edge E, as exemplarily shown in FIG. 5. Each distribution unit DU, being a subunit or subprocess of connectivity array CA, associates to each control point CPi, indexed by the variable i in the first data structure DS1 and belonging to a sub-group of control points CP, the indices (k,l) which represent the control point CPi in the parameter domain as c_{k,l} according to Equation (3), thereby (k,l) representing the sampled parameter domain (u,v).

Therefore, distribution unit DU, transforms the first data structure DS1 into a data array that represents a sub-region of the parameter domain. The data representation of distribution unit DU is equivalent to establishing the relationship between each face and its vertices because DU represents a unique identification between each face, as shown in FIG. 5, as shown in a simplified and exemplary manner as F1, F2, F3, and F4, and its control points CP1 to CP9. Moreover, the data array structure that is computed and generated by the distribution units DU, includes a representation equivalent to the parameter domain, as shown on the left in FIG. 5, where each sub-region of the parameter domain consists in different faces that might share vertices. Therefore, each face F1 to F4 can be identified only by the corner points, and hence, the faces are processed individually and independently from their neighboring faces. Thus, the processes executed in each distribution unit DU can be parallelized. A distribution unit DU processes the data stored in the first data structure DS1 such that a face F1 defined by several control points, in FIG. 5 represented in an exemplary manner by CP1, CP2, CP4, and CP5, is represented independently from a possible neighboring face F2 that shares an edge E defined by CP2 and CP5 with face F1. The global connectivity established by all distribution units DU between the control points CP represent the geometric object O in parameter space u, v and can be temporarily stored on a memory device 29. The control points CP that interpolate the geometric object O are processed by the distribution unit DU1, as exemplarily shown in FIG. 6A, whereas the control points CP that interpolate higher order derivatives are processed by the distribution units DU2, DU3, . . . , DUj, see exemplarily in FIG. 6B.

It is noted that FIG. 6B exemplarily only shows the distribution unit DU2 with respect to an exemplary object O that has nine corners as shown in FIGS. 2-3, with control points CP10 to CP18 that interpolate the higher order derivatives that correspond to the first-order derivatives. However, many more distribution units DU2 to DUⱼ are also used, as exemplarily shown in FIG. 4, where each distribution unit DU corresponds to one order of a derivative, except the first one, which represents that control points that interpolate the surface itself. Each distribution unit DU has a corresponding H-spline data representation unit HDR, which converts the sub-region of the parameter domain that is represented by the corresponding distribution unit DU into coordinate data of the coordinate domain, thereby the HDR keeping the connectivity (k,l) that has been generated by the DU which represents the data in the parameter domain (u,v). Thus, the number of distribution units DU is equivalent to the number of H-spline data representation units HDR.

If a face F is refined, the corresponding distribution units DU process the control points CP that define the face F such that new control points CPR are generated, where several newly generated control points CPR enclose a newly generated face, herein denoted as sub-face SF, as exemplarily show in FIG. 7B. The simple adding of new refined control points CPR does not change the shape of the geometric object O, as shown in FIG. 7A. The generated CPR are added to the first data structure DS1 as well as the second data structure DS2 as a processed output of the connectivity array CA, which includes all the distribution units DU and H-spline data representation units HDR together, as exemplarily shown in FIG. 7C.

The data contained in the first data structure DS1 and which is processed by the distribution units DU, including the possibly newly generated control points CPR, are sent to the H-spline representation units HDR, as exemplarily shown in FIGS. 4, 6, 7C. The linking between the DU and the corresponding HDR is established through functions that allow either the DU or the HDR or both to access the data in the memory that is computed and generated by its corresponding unit DU/HDR. The HDR includes the digital H-spline data and processes the output generated by its corresponding DU. This output corresponds to the processed first data structure, i.e. data of the DS1 processed by the DU, which is arranged and indexed according to the parameterization represented by (k,l), as given by Equation (3), where (k,l) corresponds to samples of the parameter domain (u,v). Using the DU output data the HDR creates the coordinate data in the chosen coordinate domain that is stored in the second data structure DS2 and which is used to represent the geometric object O, for example by a rendering process on a display screen 22. The H-spline data representation units HDR are configured such that they generate the samples of coordinate data of the coordinate domain, for example in x, y, z of the faces F and possible subfaces SF based on the rearranged control points CP and possibly CPR according to the group of control points that they represent; either control points CP that interpolate the geometric object O or control points CP that interpolate higher order derivatives of the geometric object O. The generation of the coordinate data by the HDR is described in Equation 7 of U.S. application Ser. No. 15/177,303 filed on Jun. 8, 2016. The number of samples that are generated are defined by the sampling rate as an input to the connectivity array CA.

As discussed above, the connectivity array CA is a bi-directional processing unit that can process data in both directions, that defines and generates a one-to-one mapping between the first data structure DS1 and the second data structure DS2. For example, a change to data of DS2 will result in a data processing by the CA that leads to changes to the data of DS1, i.e. the control points, and a change to data of DS1 will result in a data processing by the CA that leads to changes to the data of DS2.

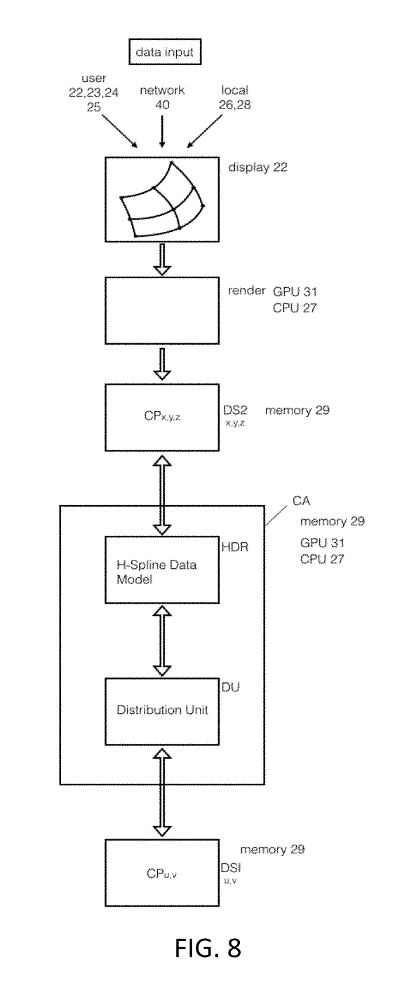

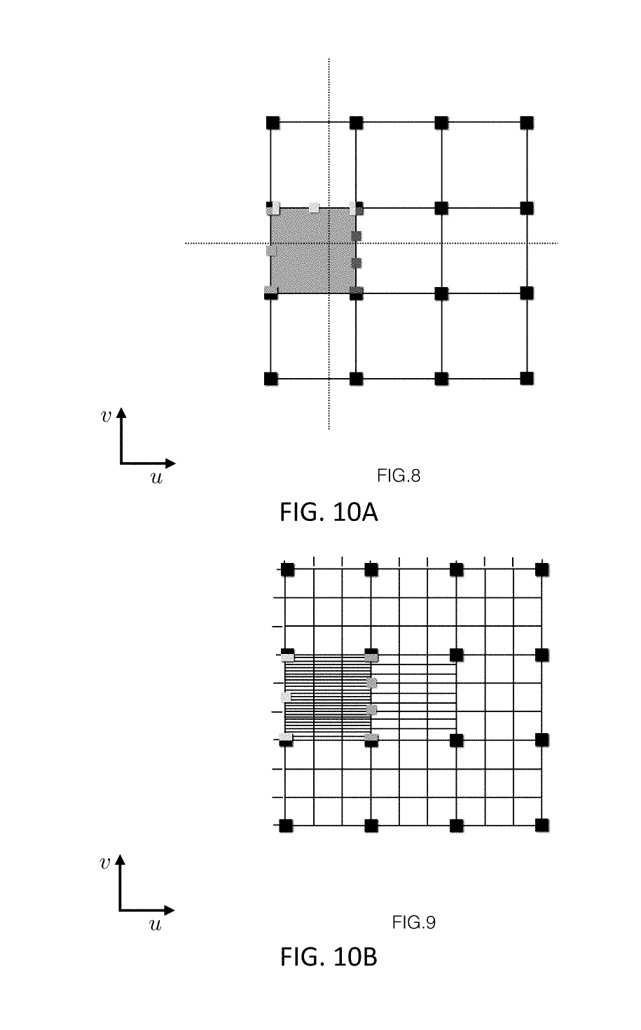

Next, a local refinement operation is described with FIGS. 7D and FIG. 8, as an exemplary data processing method. In a step S110, a geometric object O is displayed on a display screen 22 that is rendered in a step S120 on a GPU 31 or a CPU 27. In a step S130 a face F of the geometrical object O is selected, for example as shown in FIG. 10A based on a selection event previously initiated either via user input device 22, 23, 24 or 25 or via a network input 40 or a possible local input device 26, 28. The selection pipeline is ultimately linked to the second data structure DS2, which contains the coordinate data in the coordinate data domain and is stored on a memory device 29. The selection of a face F of the geometric object O by an input combined with a triggering event to indicate a refinement operation, which is also processed upon input, selects the corresponding CPs that define face F and that are stored in the second data structure DS2, which in turn, causes the connectivity array CA, and more specifically, the H-spline data representation units HDR to process and re-compute the coordinate data for the corresponding CP. In a step S140, the H-spline data representation unit HDR sends the relevant CP information to its associated distribution unit DU, which computes the refinement of the face F and generates new control points CPR. The newly generated control points CPR are added and stored to the first data structure DS1 and sent to the H-spline data representation unit HDR, which generates the coordinate data in the coordinate domain of the refined control points CPR as well as the samples of the refined face based on its configuration that encodes the H-spline data model. The refined control points CPR are added to the second data structure DS2 and the all the samples of the geometric object O are further processed by a rendering device, for example GPU 31 or CPU 27 and then further displayed on a display device 22.

Next, the bi-directional unique functional structure of the connectivity array CA is explained, and the relationship between distribution units DU and H-spline data representation units HDR. If the first data structure DS1 is changed, an input to the connectivity array CA triggers a processing event in the distribution units DU, which computes the connectivity and arrangement of the control points CP, by defining the faces F through iteration over the corresponding control points CP, including a possible generation of refined control points CPR, as exemplarily shown in FIG. 9A. As the distribution units DU act as converters between the first data structure DS1 and the connectivity that is equivalent to the representation in the parameter domain indexed by (k,l) and specified in Equation (3), each face, as exemplarily shown in FIG. 9A as F1, F2, F3, F4, is uniquely defined by its four defining vertices CP1, CP2, CP5, CP4, as exemplarily shown for the face F1. The DU is configured such that the iteration over these vertices is processed in a specific order, in FIG. 9A exemplarily shown as clock-wise iteration, leading in the unique definition of face F1. Each DU creates a data array that represents the control points CP indexed by (k,l) as specified in Equation (3), with (k,l) representing samples of the parameter domain (u,v) such that these data can be read and converted by a corresponding H-spline data representation unit HDR. These data is then reconstructed in the coordinate domain as coordinate data in x,y,z space according to Equation (3) and the representation that has been generated by the distribution units DU.

The same processing event is triggered if the input is generated by the H-spline data representation units HDR, the triggering possibly originating through prior selection of a face F combined with a secondary triggering event to execute a refinement operation. In case the data of the control points CP in the parameter space u,v has been changed by the processing operation carried out by the distribution units DU (e.g. generation of new control points CPR), then the first data structure DS1 is modified and stored on a memory device 29. In all cases, the output of the distributions units DU is processed by the H-spline data representation units HDR, which generate the coordinate data that represents the control points CP as well as all the samples of the geometrical object O such that they can be rendered by a rendering device 31, 27, as exemplarily shown in FIG. 9B.

If the second data structure DS2 is changed an input to the connectivity array CA triggers a processing event in the H-spline data representation units HDR, which is configured to compute the arrangement of the control points CP based on the H-spline data model using the coordinate data. The processed second data structure DS2 is then sent to the distribution units DU.

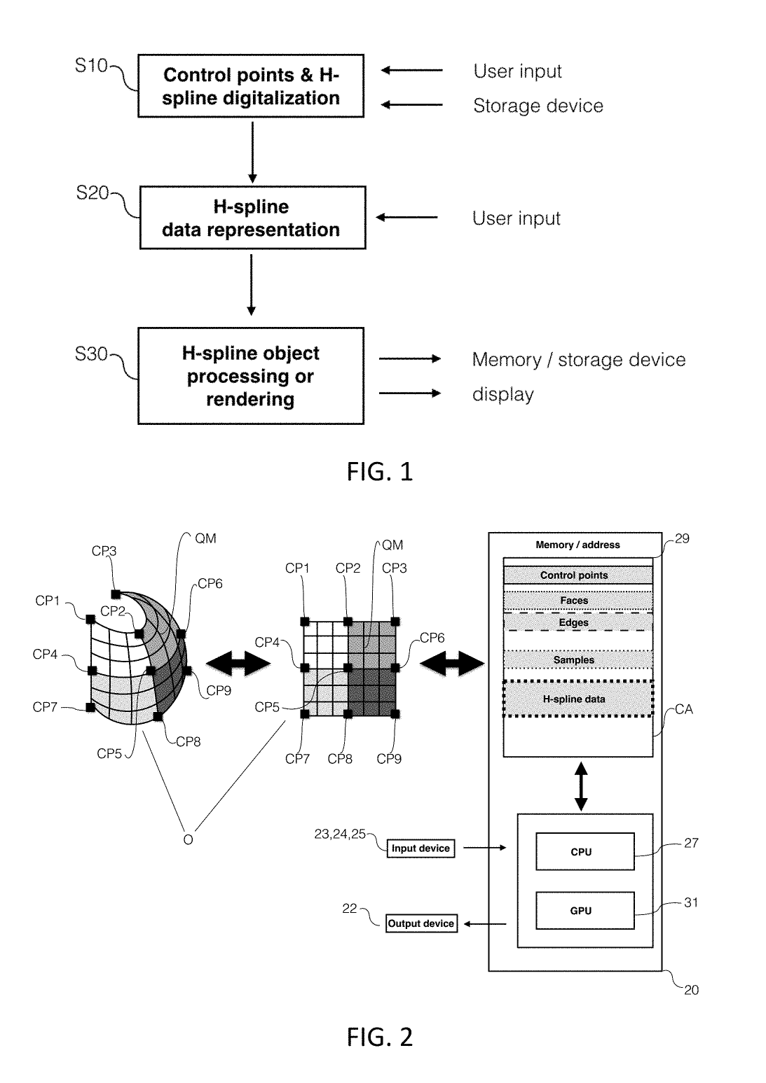

As illustrated in FIG. 1, a basic method and system to determine, represent, and render graphical objects with the H-spline representation are shown comprising the steps s10 to digitally store control points CP and the H-splines, a step s20 to represent a geometric object O using the H-spline data model, and a step s30 to process and render the geometric object O using a display device 22. First, the control points which define the geometry are either specified on a memory device, for example a memory device that is internal to the computer 20, from the network server 50, or from an external storage medium 30, 32, or are provided by user input, for example from input devices such as 23, 24, 25, or directly via interaction by display screen 22, for example by a touch screen interface. For example, in an interactive CAD setting, for example a graphical user interface that displays a rendered graphical object, and the control points associated with different faces of the graphical object, that can be interactively modified by the user. The specification of the control points, either through user interaction or any kind of computational device, defines the shape of the digital H-spline shape, to which we refer to as H-spline digitalization, in a step S10.

The H-spline digitalization defines the H-spline representation, referenced as step S20, which is the actual construction and generation of an H-spline shape as data stored in a memory. It does not only involve the creation of the data structure related to the control points but also the digital generation of the H-spline function itself and its internal representation, for example by use of a processor 27, 31, of the computer 20, 50. At this stage, again, user-input might via 22, 23, 24, 25 may be possible, for instance in an interactive CAD process, where through modification of the control points the H-spline representation is influenced, in particular the shape of the object. Another possible way of user input might be the modification of the coordinates of control points through manual specification of its values. This can be done by directly typing in the values to computer 20 via keyboard 24, as schematically shown in FIG. 2.

The data structure which generates the H-spline geometry representation might possibly be further processed and transferred to another computational unit 31 such as a GPU or rendering unit, for example a dedicated graphics processor of computer 20, in order to be displayed on a graphical display 22 as a rendered object, in a step S30. This step involves the definition of the digital sampling rate of the geometry (FIG. 10B), computation and generation of the data structure, which represents the samples, smoothness, normals, tangents and other data that must be generated in memory or that are needed to render and display the object.

In practice, any watertight H-spline surface or solid that includes different H-spline patches can readily be converted into its individual patches, where each patch has a structure as illustrated in FIG. 5. Each patch can be computationally processed individually. The control points that for instance can be interactively manipulated by a computer mouse 23 to control the geometry, or be manipulated by another data processing method such as by changing their value through a user input with the keyboard 24, or other type of data input device to computer 20, are also directly linked to the parameter domain, i.e. they are simultaneously also control points of the parameter domain. On the other hand, the values, i.e. coordinates, of the control points have a physical address in memory 29 and, therefore, any input such as an interactive user input which modifies the values of the control points immediately accesses the physical address in memory 29 where the values of the control points are stored.

Other entities that are directly linked to the geometry of the H-spline object are also stored in memory 29 such as the faces, the connectivity array, the samples of the geometry and other data related to the geometry. The memory 29 can be a random access memory operatively connected to a hardware structure with a CPU 27 and possibly a GPU 31. Furthermore, the hardware structure having the CPU 25 is operatively connected to input and output devices, such as, but not restricted to, a computer mouse 23, keyboard 24, display 22, for example a computer screen having touch screen interface, audio-related hardware such as a headphone, microphone or a speaker system (not shown).

As shown in FIGS. 4 and 6, the H-spline digitalization of a geometrical object O is generated by the control points CP, which are stored in memory 29. The H-spline data representation of step S20 (see FIG.1) then additionally requires the generation of the samples of the geometrical object by definition of the sampling rate as shown in FIG. 3B, which is either stored on an external storage device or given as a user input.

The connectivity of all the samples among each other is processed in the H-spline representation unit HDR that generates the connectivity array in memory as shown in FIG. 9B. It consists in several data arrays that store the information of each vertex, its neighboring vertices and positions in memory.

Different faces F1, . . . , Fi, can be accessed in memory individually, possibly through an interactive user-input to modify the geometry that is represented by a particular face.

For example, with control points CP4, CP5, CP7, and CP8, the geometry of face F3 can be modified as shown in FIG. 3A. The faces can be stored in memory and processed in parallel by the CPU 27 or possibly the GPU 31 and also rendered and displayed on display 22 independently from each other and different methods related to the processing of the data of the graphical object can be parallelized.

According to another aspect of the present invention, it is possible to apply a local refinement to the faces of the graphical object O. This is exemplarily illustrated in FIG. 7A to show local refinement of an edge of the face F1. Local refinement is generated by a possible user or numerical input, where digitally the number of control points CP that define the edges E of one or several faces, for example F1, is changed and the new values for the additional control points CPR1, CPR2, CPR3, CPR4, and CPR5 are stored in memory. Thereby, the set of edges E, which define a face F, can all have a different number of control points CP, as shown exemplarily in FIG. 9B. In addition, by adding a local refinement, for example by adding control points CPR1, CPR2, face F1 is split into several subfaces SF1, SF2, SF3, and SF4. This additional data is then generated and stored to the first data structure DS1 and the second data structure DS2. If a specific point on the geometry, which is represented by a corresponding point in the parameter domain, is accessed, either through a user input or otherwise, through the data structure that generates the connectivity array the face which contains the geometry point can immediately be identified to accelerate any related H-spline object processing or computation.

The independency of the faces Fi and the face data structure enables to have different sampling, refinement or control point structure per face as schematically represented in FIG. 10B.

The modular data structure generated in memory enables to process any information related to a face individually, thereby, through the digital connectivity array, which links the geometry-related information stored in different physical addresses, to process information as a whole if a certain operation is applied to the whole geometrical object. For example, if the whole object needs to be translated, through the information generated and stored in the connectivity array, the new coordinates of all the control points, samples and other required data are immediately computed in a possibly parallelized manner.

Each computation unit in the connectivity array CA updates the faces of the geometric object O object directly according to the updated control points. Every computation unit is independent and hence, this update process is parallelizable, and can be sent to an independent CPU thread. Together with the user digitalization input (number of samples per face), the H-spline object is discretized and converted into polygon quad-mesh data and sent to a GPU 29 in order to draw each of them separately.

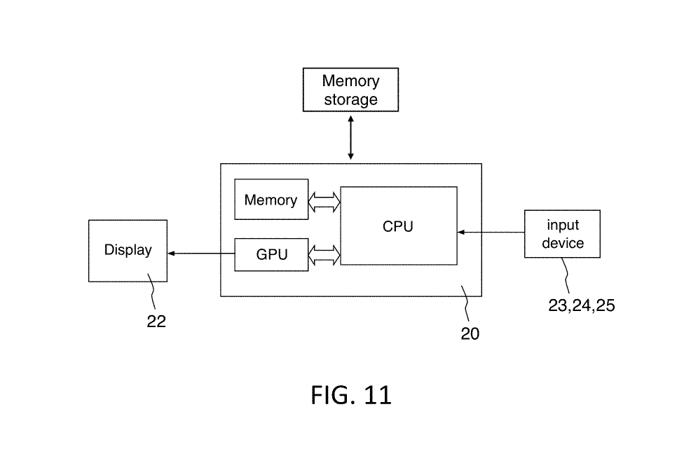

As shown in FIG. 11, a simplified scheme is shown for a system to generate, represent, and store geometrical objects using H-splines in a computing environment including input devices 23, 24, 25, computing device 20, and display 22, the computing device including a CPU, a GPU, and memory. Usually, in a first step, an H-spline based CAD model, possibly but not necessarily having been stored on a memory storage device, is defined as input to 20, which generates the above described data structure in memory for the digital representation using H-splines. The user can control and specify the geometry with an input device such as 23, 24, 25, to generate a graphical element computed with 20 and 22. The specification of the H-spline based data is executed by specification of the digital geometry representation through user interaction by 23 or 25. For example, this can be done by dragging and displacing H-spline related parameters, such as control points or sampling rate with input device 23, 25 and by global or local refinement computed through the processing unit 20, or automatically or user-defined, such as by specifying mesh parameter values with device 24, and then possibly displaying the interactively defined or modified or semi-automatically or automatically generated data on the display while performing interaction with an input device 23, 25.

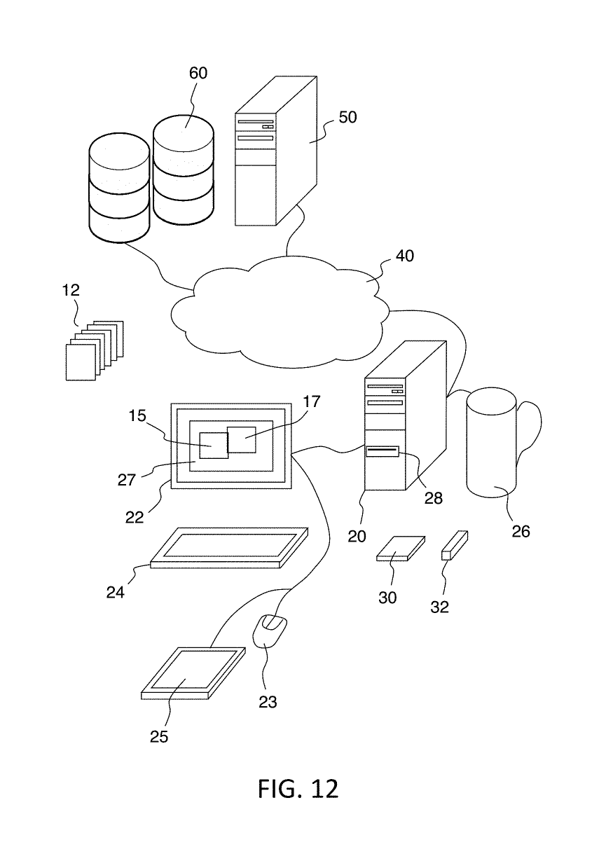

FIG. 12 shows a perspective view of an exemplary device and system for implementing the method described above. The system includes a data processing device 20, for example but not limited to a personal computer (PC), Macintosh™ computer, laptop, notebook, netbook, data processing workstation, smartphone, or a tablet. A dataset 12 is schematically shown, that can be located locally in a storage 26 associated with processing device 20, or can be accessed via the network 40, for example the Internet, from various remotely located devices, for example servers 50 and storage 60. Processing device 20 can be equipped with one or several hardware microprocessors, dedicated graphics processors such as but not limited to graphical processing units (GPU), central processing unit (CPU) and with internal memory. Also, processing device 20 is connected to a data input device, for example a keyboard 24 to provide for user instructions for the method, computer mouse 23, or trackpad 25, and a data display device 22, for example a computer screen, to display different stages and final results of the data processing steps of the method. An exemplary processing device 20 with display device 22 and data input devices 23, 24, 25 is shown in FIG. 11. The display device 22 is capable of displaying 2D or 3D images to represent results and processing steps of the method. For example, the graphical user interface 27 can be shown, that is displaying the H-spline based ASG generated based on an H-spline based CAD model, and the shapes and appearance of possible ASG models 15, 17 can be changed directly and in real-time via the data input devices 23, 24, 25. This allows performing the direct surface control described above using H-splines.

The data input devices 23-25 can also be used directly control the control points of the H-spline based ASG 15 and 17 and its higher order derivatives via CPU. The modified surfaces are computed in terms of rendering primitives, which are processed in real time by a GPU to construct the graphics object and displayed by a display device 22. External memory, main memory (RAM) and graphics memory (VRAM) allow one for real time shape interaction through a display refresh rate of typically 60 Hz for modern computer screens 22, such as but not limited to liquid crystal device (LCD) monitors, based on frame buffer updates of the graphics objects that describe the surfaces 15 and 17.

Also, the interpolatory control points and control points that interpolate higher order derivatives that are associated with the parameterization of the ASG models 15, 17 etc. can also be represented on computer screen 22. Processing device 20 is also connected to a network 40, for example the internet, to access various cloud-based and network-based services, for example but not limited to cloud or network servers 50, cloud or network data storage devices 60, specific web servers providing databases of graphics data.

The method described above can also be performed on hardware processors of one or more servers 50, and the results sent over the network 40 for rendering and display on computer screen 22 via processing device 20. Processing device 20 can be equipped with a data input/output port, for example a CDROM drive, Universal Serial Bus (USB), card readers, storage device readers, to read data, for example computer readable and executable instructions, from non-transitory computer-readable media 30, 32. Non-transitory computer-readable media 30, 32 are storage devices, for example but not limited to external hard drives, flash drives, memory cards, USB memory sticks, CDROM, Blu-Ray™ disks, optical storage devices and other types of portable memory devices that are capable of temporarily or permanently storing computer-readable instructions thereon. The computer-readable instructions can be configured to perform the method, as described above, when loaded to processing device 20 and executed on a processing device 20 or a cloud or other type of network server 50, for example the one shown in FIG. 15.

According to some aspects of the invention, the system and method can substantially facilitates the modeling process in CAD, computer-aided engineering (CAE), and computer-aided manufacturing (CAM) in the fields of mechanical modeling, industrial design, digital fabrication and manufacturing, as well as computational fluid dynamics and related fields and also animation and character design. Examples of areas of application can also be found in the automotive, naval, and aerospace industry, product design, architectural modeling as well as the design of games and animated movies. According to aspects of the invention, substantial advantages are provided by the more efficient description of ASG through H-splines, enabling faster and simpler design of possibly complex watertight surfaces which can also be exploited for rapid execution of computational optimization schemes such as in any kind of mechanical modeling processes, aero- and aquadynamics, fast surface deformation processes as used in simulation and animation or the exchange and communication of protocols describing high quality surfaces with 3D printing devices, CNC machines or industrial robots. Furthermore, according to some aspects of the present invention, the system and method allows to design surfaces and generate ASGs that can adopt shapes that are beyond the possibilities of what existing technology can offer.

While the invention has been disclosed with reference to certain preferred embodiments, numerous modifications, alterations, and changes to the described embodiments, and equivalents thereof, are possible without departing from the scope of the invention. Accordingly, it is intended that the invention not be limited to the described embodiments, and be given the broadest reasonable interpretation in accordance with the language of the appended claims.

1. A method for generating a data structure to digitally represent a geometrical object based on H-splines, the method being performed on a computer device having a data processor and memory, the method comprising the steps of:
creating a first data structure and storing a plurality of control points and higher order derivatives that define the geometrical object in a parameter domain using the H-splines in the first data structure of the memory;
creating a second data structure and storing coordinate data that define the geometrical object as a coordinate data model in the second data structure of the memory; and
creating and storing a connectivity array in the memory that links the plurality of control points of the parameter domain to the coordinate data of the coordinate data model.

2. The method according to claim 1, further comprising the steps of:
displaying a rendered object of the geometrical object by accessing data from the second data structure with a graphics processor; and
manipulating a display of the rendered object by changing a value of the plurality of control points of the first data structure with at least one of an input device, data from the memory, and by another data processing method.

3. The method according to claim 1, further comprising the steps of:
changing a shape of the geometrical object by accessing and changing a value of the plurality of control points of the first data structure with at least one of an input device, data from the memory, and by another data processing method.

4. The method according to claim 1, wherein each one the plurality of control points includes at least one of coordinate values having an address in the memory such that each control point interpolates the geometrical object based on H-splines, and data having an address in the memory corresponding to the higher order derivative of the geometrical object based on H-splines.

5. The method according to claim 1, wherein the connectivity array includes a set of distribution units and a set of H-spline representation units, the set of distribution units defining a relationship between faces of the geometrical object and corresponding control points of the faces.

6. The method according to claim 1, wherein the second data structure of the memory physically encodes the control points in coordinate data space and the higher order derivatives in the coordinate data space and physically encodes the connectivity between the control points by H-spline interpolation.

7. The method according to claim 1, further comprising the steps of:
creating data that represent a surface of the geometric object, the surface corresponding to a first surface in the parameter domain represented by the first data structure and to an analogous second surface of the coordinate data model represented by the second data structure; and
creating data by the connectivity array that represents edges that define the surface, each edge corresponding to a first edge in the parameter domain stored in memory using the first data structure and to an analogous second edge of the coordinate data model stored in memory using the second data structure.

8. The method according to claim 1, further comprising the step of:
creating data that represent a plurality of surfaces and storing the data in the memory, the plurality of surfaces together define all the surfaces of the geometrical object in the coordinate data model of the second data structure.

9. The method according to claim 7, wherein the data representing the surface can encode a local refinement.

10. The method of claim 1, further comprising the step of:
creating data that represent a first surface and a second surface of the geometric object;
modifying coordinates of control points that interpolate higher order derivatives of the first surface and of the second surface with an input device, and
interactively displaying the first surface and the second surface with modified control points on a display device.

11. The method according to claim 1, further comprising the step of:
creating data that represent a first surface and a second surface of the geometric object;
modifying a resolution of a first surface of the geometrical object in the coordinate data model of the second data structure independently from the second surface based on at least one of data inputted by a user, data stored in the memory, and data from another data processing device.

12. A system for generating a data structure to digitally represent a geometrical object based on H-splines, the system including a computer device having a data processor and memory, the data processor configured to
create a first data structure and store a plurality of control points and higher order derivatives that define the geometrical object in a parameter domain using the H-splines in the first data structure of the memory;
create a second data structure and store coordinate data that define the geometrical object as a coordinate data model in the second data structure of the memory; and
create and store a connectivity array in the memory that links the plurality of control points of the parameter domain to the coordinate data of the coordinate data model.

13. The system according to claim 12 further comprising a graphics processor and a display device, the graphics processor configured to
display a rendered object of the geometrical object by accessing data from the second data structure; and
manipulate a display of the rendered object after a change of a value of the plurality of control points of the first data structure with at least one of an input device, data from the memory, and by another data processing method.

14. The system according to claim 12, wherein the processor is further configured to
change a shape of the geometrical object by accessing and changing a value of the plurality of control points of the first data structure based on at least one of an input device, data from the memory, and by another data processing method.

15. The system according to claim 12, wherein the connectivity array includes a set of distribution units and a set of H-spline representation units, the set of distribution units defining a relationship between faces of the geometrical object and corresponding control points of the faces.

16. A non-transitory computer readable medium, the computer readable medium having computer instruction code recorded thereon, the computer instruction code configured to perform a method for generating a data structure to digitally represent a geometrical object based on H-splines, the method comprising the steps of:
creating a first data structure and storing a plurality of control points and higher order derivatives that define the geometrical object in a parameter domain using the H-splines in the first data structure of a memory of the computer;
creating a second data structure and storing coordinate data that define the geometrical object as a coordinate data model in the second data structure of the memory of the computer; and
creating and storing a connectivity array in the memory that links the plurality of control points of the parameter domain to the coordinate data of the coordinate data model.

17. The non-transitory computer readable medium according to claim 16, further comprising the steps of:
displaying a rendered object of the geometrical object by accessing data from the second data structure with a graphics processor; and
manipulating a display of the rendered object by changing a value of the plurality of control points of the first data structure with at least one of an input device, data from the memory, and by another data processing method.

18. The non-transitory computer readable medium according to claim 16, further comprising the steps of:
changing a shape of the geometrical object by accessing and changing a value of the plurality of control points of the first data structure with at least one of an input device, data from the memory, and by another data processing method.

19. The non-transitory computer readable medium according to claim 16, wherein the connectivity array includes a set of distribution units and a set of H-spline representation units, the set of distribution units defining a relationship between faces of the geometrical object and corresponding control points of the faces.

20. The non-transitory computer readable medium according to claim 16, wherein the second data structure of the memory physically encodes the control points in coordinate data space and the higher order derivatives in the coordinate data space and physically encodes the connectivity between the control points by H-spline interpolation.
